(19) United States
(12) Patent Application Publication
(10) Pub. No.: US 2004/0078610 A1
(43) Pub. Date: Apr. 22, 2004

(54) Image recording apparatus capable of addressing unexpected power supply interruption and method therefor

(76) Inventor: Tadahiro Naitoh, Osaka (JP)

Correspondence Address: ROSENTHAL & OSHA L.L.P., 1221 MCKINNEY AVENUE, SUITE 2800, HOUSTON, TX, 77010, US

(21) Appl. No.: 10/664,574

(22) Filed: Sep. 17, 2003

(30) Foreign Application Priority Data
Sep. 26, 2002 (JP) 2002-281127(P)

(51) Int. Cl. H04N 7/00; G06F 1/28

(52) U.S. Cl. 713/300; 386/46

(57) ABSTRACT

A PVR portion recording image data in an HDD is controlled by a sub-microcomputer. When power supply is started, the sub-microcomputer determines whether a flag is remained to be set or not, i.e., if the flag can not be reset due to an interruption of previous power supply during a recording operation. As a result, if the power failure during the image recording is detected, it notifies a recovery instruction to PVR portion. When PVR portion accepts the notice, it retrieves the image file from HDD that has been interrupted while being recorded, and closes the retrieved file to set it as an effective file. Additionally, it also determines image recording scheduling information, and if the image recording scheduling period is remained, the image recording operation is continued according to the scheduling information.

### BACKGROUND OF THE INVENTION

1. Field of the Invention

The present invention relates to an image recording apparatus having a function of recording image information in a recording medium and a method therefor, and specifically, to an image recording apparatus capable of addressing a sudden interruption of power supply.

2. Description of the Background Art

As techniques related to a recovery from a power failure for an image recording apparatus, the followings have been proposed. For example, Japanese Patent Laying-Open No. 4-301249 discloses a magnetic record playback apparatus in which clock data, program data and the like stored in RAM (Random Access Memory) are recovered when they are deleted by a power failure.

For example, Japanese Patent Laying-Open No. 8-335342 discloses an automatic clock setting apparatus used for a VTR (Video Tape Recorder) in which a position necessary for automatic clock setting is tuned when recovered from a power failure to recover clock data.

For example, Japanese Patent Laying-Open No. 9-275540 discloses a VTR that communicates with a microcomputer thereof for obtaining information of time at which recording is interrupted. In response, the microcomputer displays the information.

For example, Japanese Patent Laying-Open No. 2000-354221 discloses a broadcast information record playback system that notifies a communication apparatus such as a mobile phone and a PHS (Personal Handy phone System) that scheduling information is lost due to a power failure, such that a timer and the like may be reset using the communication apparatus.

These techniques only enable to recover (reset) scheduling data, clock information and the like when the image recording apparatus is recovered from the power failure, and do not disclose any procedure for recovering data, of which recording has been interrupted by the power failure as normal data.

### SUMMARY OF THE INVENTION

An object of the present invention is to provide an image recording apparatus capable of recovering recorded contents normally when the power failure ends and the power is supplied again, and a method therefor.

In order to achieve above-described object, according to one aspect of the present invention, an image recording apparatus includes: a recording portion being supplied with power to record at least digital image information in a recording medium by files, and a control unit operating when being supplied with the power to control the recording portion.

The control unit includes a recovery portion for controlling the recording portion, when a power supply to the control unit is started and if previous power supply is found to be interrupted during a recording operation, to retrieve a file having been recorded at the interruption of the power supply from the files and to close the retrieved file.

Accordingly, if the file having been recorded is not closed normally due to the interruption of the power supply during the recording operation of the recording portion, the recovery portion controls the recording portion when the power supply for the control unit is started, to retrieve the file having been recorded and to close it.

Therefore, even when the file having been recorded is not closed due to the sudden interruption of the power supply because of a sudden power failure or the like during the recording operation, the file can be closed at the start of the power supply that follows to recover the recorded contents normally.

Preferably, the above-described control unit further includes a flag setting portion for setting a pre-prepared flag during a period in which power is supplied to the recording portion, and for resetting the pre-prepared flag when power to the recording portion is interrupted, and a power interruption detecting portion for detecting, when a power supply to the control unit is started and if the flag is determined to be set, an interruption of previous power supply during a recording operation.

Accordingly, if there has been no power failure during a recording operation i.e., power has been supplied constantly and it ends normally, the flag is reset when a power supply is started thereafter. On the other hand, if a power supply is interrupted due to a power failure or the like during a recording operation, the flag setting portion of the control unit is no longer capable of setting the flag, and a power supply is started thereafter while the flag is remained to be set.

Therefore, the power interruption detecting portion can easily detect, when the power supply is started again, that the previous power supply is interrupted based on the flag being set.

In the above-described image recording apparatus, preferably the recorded contents of the recording medium are retained after the interruption of the power supply. The control unit further includes an information storing portion retaining pre-recorded information during a period in which power is supplied to the control unit, a scheduling information recording portion for accepting scheduling information for scheduling a recording operation by the recording portion and recording the accepted scheduling information in the recording medium and in the information storing portion, and a supply start time recording portion for recording the scheduling information read from the recording medium in the information storing portion, when a power supply to the control unit is started.

Accordingly, even when the recording information including the scheduling information of the information storing portion is not retained due to the interruption of the power supply because of a power failure or the like, at the start of a power supply to the control unit that follows, the same scheduling information in the recording medium that is retained regardless of the power failure is read and recorded in the information storing portion.

Therefore, even when the scheduling information in the information storing portion is not retained due to the interruption of the power supply because of a power failure or the like for the controlling portion that controls the recording portion, the scheduling information can be recovered in the information storing portion.

Preferably, in the above-described image recording apparatus, the scheduling information includes scheduling period data for scheduling a period of the recording operation. The control unit further includes a real time clock measuring real time. When a power supply to the control unit is started and if the real time measured by the real time clock is in a scheduling period indicated by the scheduling period data of the scheduling information recorded in the information storing portion by the supply start time recording portion, the control unit causes the recording portion to resume the recording operation based on the scheduling information.

Accordingly, even when the power supply is interrupted due to a power failure or the like during the recording operation based on the scheduling information, at the start of a power supply that follows, the recording operation can be resumed based on the scheduling information if it is in the scheduled period of the scheduling information recovered in the information storing portion as above.

Preferably, the above-described recording medium is a hard disk. Accordingly, the above-described function and effect can be attained even when the power supply is suddenly interrupted due to a power failure or the like when recording image information by files in the hard disk.

Preferably, the above-described image recording apparatus further includes a playback portion playing back and outputting the recorded contents of the recording medium. Accordingly, in the same apparatus, the information can be recorded in the recording medium and to be played back and output from the recording medium.

Preferably in the above-described image recording apparatus, power is supplied from a commercial power source, and the power supply from the commercial power source is interrupted by a power failure.

Accordingly, even when the power supply from the commercial power source is interrupted due to the power failure, the recovery as described above is possible.

An image recording method according to another aspect of the present invention includes a recording step of being supplied with power from a power source to record at least digital image information in a pre-prepared recording medium by files, a power interruption detecting step of detecting if previous power supply is interrupted during a recording operation, and a recovering step of retrieving a file having been recorded at an interruption of the power supply and closing the retrieved file, if the interruption of the power supply is detected in the power interruption detecting step.

Accordingly, when a file having been recorded is not closed normally due to the interruption of the power supply during the recording operation, the file having been recorded is retrieved to be closed.

Therefore, even when a file having been recorded is not closed due to the sudden interruption of the power supply because of the power failure or the like during the recording operation, the file having been recorded is retrieved to be closed, and thus the recorded contents can be recovered normally.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of an image record playback apparatus according to an embodiment of the present invention;

FIG. 2 shows a configuration of PVR portion in FIG. 1;

FIGS. 3A-3C show an example of recorded contents of HDD of FIG. 2;

FIG. 4 shows in a table form operation mode of the image record playback apparatus of FIG. 1 and presence and absence of a power supply to each of a sub-microcomputer, the PVR portion and a DVD portion;

FIG. 5 is a flowchart of a scheduled image recording operation according to the present embodiment; and

FIG. 6 is a process flowchart for detecting a power failure during recording an image to recover an image file.

### DESCRIPTION OF THE PREFERRED EMBODIMENT

In the following, an embodiment of the present invention will be described in detail referring to the figures.

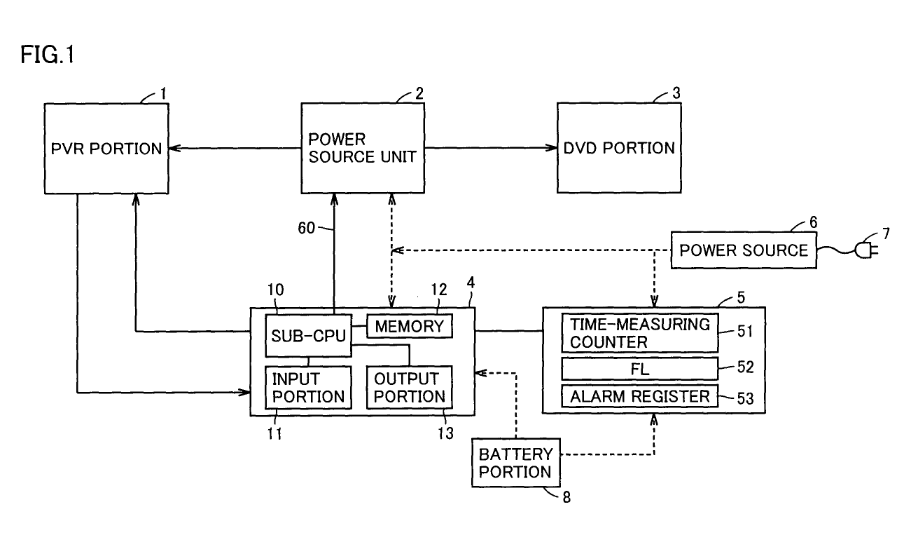

FIG. 1 shows a configuration of an image record playback apparatus according to an embodiment of the present invention. Referring to FIG. 1, the image record playback apparatus includes a PVR (Personal Video Recorder) portion 1, a power source unit 2, a DVD (Digital Video disc Driver) portion 3, a sub-microcomputer 4, an RTC (Real Time Clock) 5, a power source 6 connected to plug 7 to be mated/unmated to/from a commercial power source outlet that is not shown, and a battery portion 8 functioning as an auxiliary power source for sub-microcomputer 4 and RTC 5. In FIG. 1, broken lines indicate the supply of power, while solid lines indicate communications of a signal (including a power signal), data, information and the like.

Power source 6 supplies power to power source unit 2, sub-microcomputer 4 and RTC 5, which is supplied from a commercial power source through plug 7 inserted into the outlet.

Sub-microcomputer 4 includes a sub-CPU (Central Processor Unit) 10, an input portion 11 formed of a switch and the like provided operable externally, a memory 12 storing various programs and data, and an output portion 13 of a liquid crystal or the like for outputting various information. Sub-CPU 10 outputs a power source control signal 60 to power source unit 2.

When receiving power source control signal 60, power source unit 2 supplies power from power source 6 to both of or one of PVR portion 1 and/or DVD portion 3, based on the received power source control signal 60.

RTC 5 includes a time-measuring counter 51 serving as a clock for measuring real time, a flag register 52 storing a pre-prepared flag FL that is set by sub-CPU 10 while PVR portion 1 is supplied with power from power source 6 and reset thereafter when the power supply is interrupted, and an alarm register 53 storing information for a certain type of alarm including information for scheduled image recording, information of time of alarm clock and the like. Flag register 52 is capable of retaining the stored contents even when the power supply is interrupted.

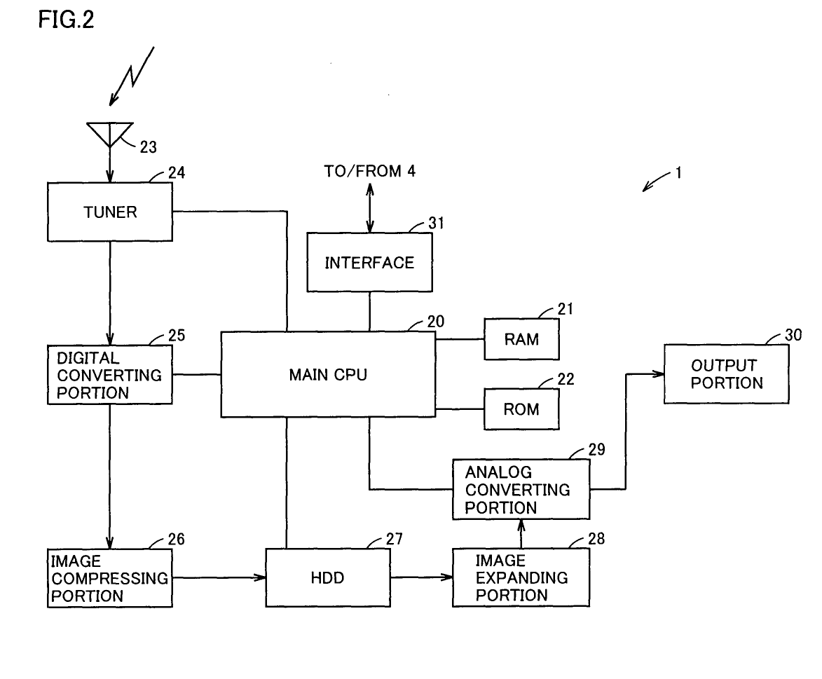

FIG. 2 shows the configuration of PVR portion 1 of FIG. 1. Referring to FIG. 2, PVR portion 1 includes a main CPU 20, RAM 21 and ROM (Read Only Memory) 22 storing various programs and data, an antenna 23 receiving a broadcast signal such as a television signal, a tuner 24 extracting a signal of the channel designated by the signal received by antenna 23, a digital converting portion 25 receiving the signal extracted by tuner 24 to convert it into digital information, an image compressing portion 26 compressing an image data that is the digital information output from digital converting portion 25, an HDD (Hard Disk Driver) 27 recording information including the compressed image data, an image expanding portion 28 expanding (decompressing, unarchiving) the image data read from HDD 27 to output it, an analog converting portion 29 converting the image data output from image expanding portion 28 into an analog signal, an output portion 30 receiving the analog signal from analog converting portion 29 and guiding it to an external apparatus (for example, a television receiver) that is not shown, and an interface 31 communicating with sub-microcomputer 4. Though not shown, HDD 27 has, for example, a digital hard disk and a control system for accessing it, and the recorded contents of the digital hard disk will be retained even when the power supply is interrupted.

Here, while the description is only given to the image processing system and not given to an audio processing system, audio information is also written and read via HDD along with image information.

A digital video disc is detachably attached to DVD portion 3. DVD portion 3 reads image and audio information from the attached disc and provides it to an output device (for example, a television receiver), not shown, to be playback and displayed thereon. Further, when provided with the contents recorded in HDD 27 of PVR portion 1, DVD portion 3 writes them to the attached digital video disc.

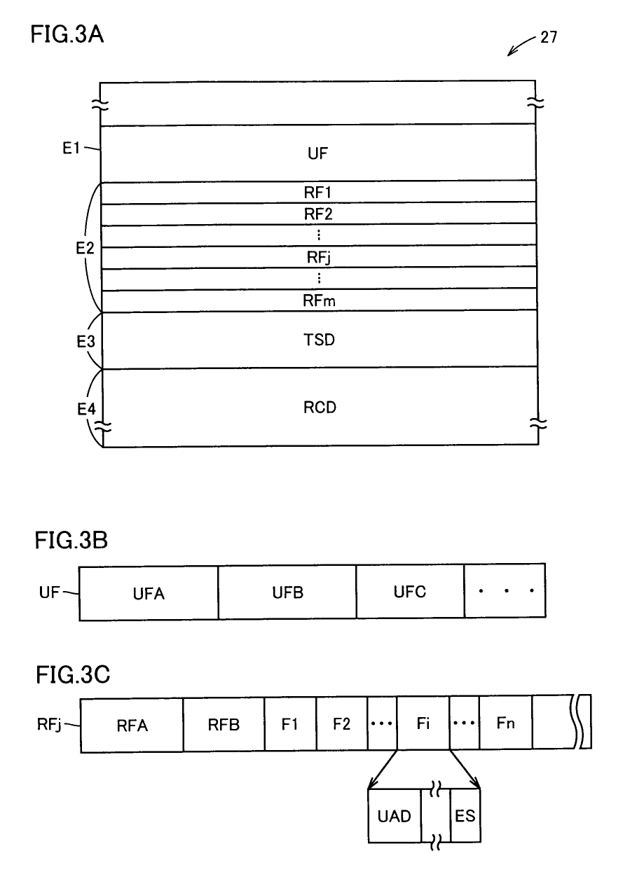

FIGS. 3A-3C show an example of the recorded contents of HDD 27 of FIG. 2. Referring to FIG. 3A, the address space of the digital hard disk of HDD 27 includes areas E1, E2, E3 and E4. Area E1 records user information UF, area E2 records image recording information RFj (j=1, 2, 3, . . . m) corresponding to each program to be recorded, area E3 records time-shift data TSD that is image data for a time-shift image recording mode, and area E4 records image recording data RCD for a normal image recording mode that is not the time-shift image recording mode.

As shown in FIG. 3B, user information UF includes current state information UFA, current program name UFB and file information identifier UFC. Current state information UFA indicates whether the data currently recorded is time-shift data TSD or image recording data RCD. Current program name UFB specifies and indicates the program name of image data currently being recorded in area E3 or E4. File information identifier UFC indicates an identifier for identifying file information Fi, which will be described later, corresponding to the file currently being recorded for the image data recorded in a file format in areas E3 and E4.

As shown in FIG. 3C, image recording information RFj includes program name information RFA indicating the name of a corresponding program, and scheduling information RFB indicating scheduling contents for a scheduled image recording of the program, and at least one file information Fi (i=1, 2, 3, . . . , n). In HDD 27, the image data of the program is recorded by files of fixed length. Here, corresponding to a file recording image data, file information Fi is formed every time the file is created. File information Fi includes a used address area UAD indicating an address area in area E3 or E4 recording a corresponding file, and an end sign ES. End sign ES is information to be written when recording of image data for the corresponding file ends, or when recording of image data of the program of the corresponding file is completed. Accordingly, whether recording of the image data for the file corresponding to file information Fi normally ends and the file is closed or not can be identified depending on whether end sign ES is recorded or not.

Image recording information RFj of area E2 of HDD 27 is information for administering and recording to which space in area E3 or E4 the corresponding program file is arranged. When accessing (reading/writing) image data of area E3 or E4, image recording information RFj of area E2 is referred to, and the access is made based on the reference result. Accordingly, even when image data (image recording data RCD or time-shift data TSD) is not defective and in a perfect state, if the contents of image recording information RFj is corrupted or incomplete, the image data (image recording data RCD or time-shift data TSD) recorded in area E3 or E4 can not be deleted or read, resulting in a wasted memory area in HDD 27 which can not be used.

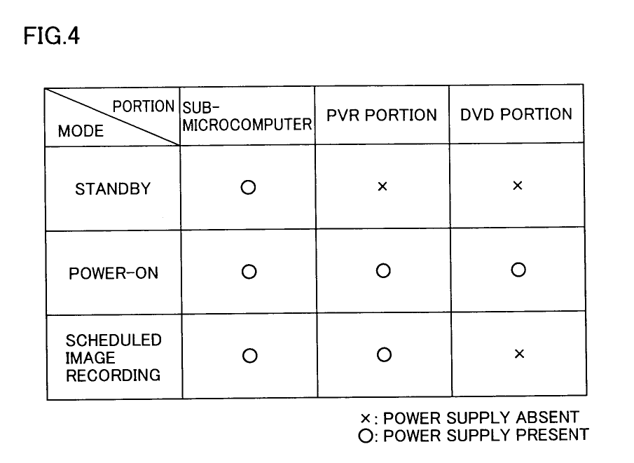

FIG. 4 shows in a table form operation modes of the image record playback apparatus of FIG. 1, and presence/absence of the power supply to each of sub-microcomputer 4, PVR portion 1 and DVD portion 3. In response to the insertion of plug 7 into an outlet, the power supply from power source 6 to power source unit 2, sub-microcomputer 4 and RTC 5 is started, and the image record playback apparatus enters into a standby mode. In the standby mode, while sub-microcomputer 4 is supplied with power from power source 6 as shown, PVR portion 1 and DVD portion 3 are not supplied with power since sub-CPU 10 outputs power source control signal 60 to power source unit 2, which is set to a level instructing not to supply power to PVR portion 1 and DVD portion 3.

Thereafter, when a user provides a power-on instruction instructing to supply power to each portion for driving (operating) through a switching operation of input portion 11 or the like, sub-CPU 10 outputs power source control signal 60 to power source unit 2, which is set to a level instructing to supply power to PVR portion 1 and DVD portion 3. When power source unit 2 receives power supply control signal 60, it supplies power supplied from power source 6 to PVR portion 1 and DVD portion 3, based on the received power source control signal 60. In such a power-on mode, as shown in FIG. 4, power is supplied to all of sub-microcomputer 4, PVR portion 1 and DVD portion 3 such that they can attain drivable (operable) state.

When the user sets image recording scheduling information of a desired program through a remote controller, not shown, or through a switching operation of input portion 11 in the standby mode, the apparatus temporalily enters into the power-on mode to carry out a procedure for setting image recording scheduling information. When the procedure ends, it goes back to the standby mode. Thereafter, at the scheduled time point, it enters into a scheduled image recording mode of FIG. 4. When it enters into the scheduled image recording mode, as sub-CPU 10 outputs power source control signal 60 to power source unit 2, which is set to a level instructing to supply power only to PVR portion 1, power source unit 2 supplies power only to PVR portion 1 so that it can drive (operate).

In each mode shown in FIG. 4, when plug 7 is unmated from the outlet, or the power supply from power source 6 suddenly stops due to a power failure or the like, the power supply form power source 6 to power source unit 2, sub-microcomputer 4 and RTC 5 stops. However, an auxiliary power is supplied from battery portion 8 to sub-microcomputer 4 and RTC 5. Accordingly, sub-microcomputer 4 can operate for a prescribed period after the power failure, and the contents of alarm register 53 of RTC 5 can also be retained for a prescribed period after the power failure.

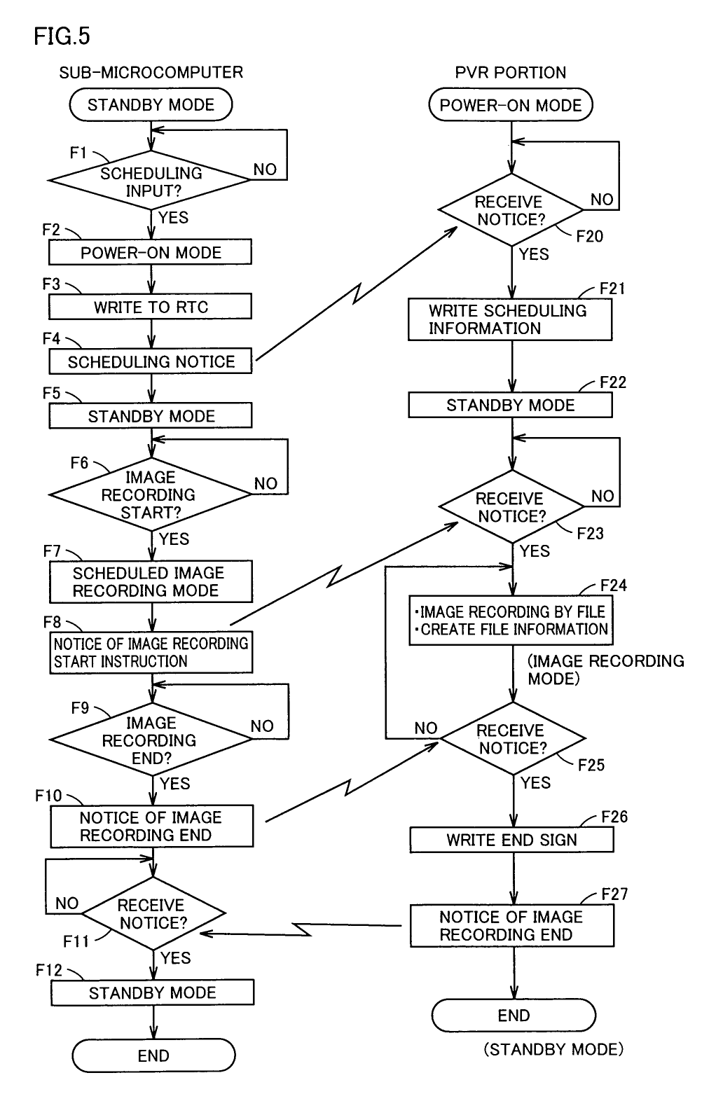

Next, referring to the flowchart of FIG. 5, the operation of scheduled image recording of the image record playback apparatus of FIG. 1 is described. Here, it is assumed that each portion of the image record playback apparatus of FIG. 1 is in the standby mode shown in FIG. 4.

First, the user inputs scheduling information for a scheduled image recording of a program, including a channel number, starting time and ending time of broadcasting the program, through the operation of input portion 11 of sub-microcomputer 4 (YES at step F (hereinafter simply referred to F) 1).

When sub-CPU 10 detects that the scheduling information is input, it outputs power source control signal 60 to cause the apparatus to exit from the standby-mode and to enter into the power-on mode (F2). Thereafter, it writes thus input scheduling information to alarm register 53 of RTC 5 (F3). Then, it notifies PVR portion 1 of scheduling information (F4). Thereafter, it outputs power source control signal 60 to cause the apparatus to exit from the power-on mode to enter into the standby mode (F5).

As PVR portion 1 enters into the power-on mode and receives the scheduling information at main CPU 20 from sub-microcomputer 4 via interface 31 (YES at F20), PVR portion 1 writes the received information into image recording information RFj of HDD 27 as scheduling information RFB (F21). Thereafter, it enters into the standby mode (F22).

In sub-microcomputer 4, after entering into the standby mode (F5), sub-CPU 10 constantly compares the program starting time of scheduling information of alarm register 53 of RTC 5 with the real time measured by time-measuring counter 51. As a result of comparison, if these times match, sub-CPU 10 determines that it is a timing to start image recording (YES at F6), and outputs power source control signal 60 such that the apparatus enters into the scheduled image recording mode (F7). Then, it notifies PVR portion 1 of an image recording start instruction.

At this time, since PVR portion 1 is in the scheduled image recording mode, main CPU 20 receives the image recording start instruction via interface 31 (YES at F23). Receiving the image recording start instruction, main CPU 20 starts image recording based on the contents of scheduling information RFB that has been written into image recording information RFj (F24). In other words, since tuner 24 is adjusted to extract a broadcast signal of the channel indicated by scheduling information RFB, the broadcast signal of that channel (the broadcast signal of the program) is extracted from tuner 24. The extracted broadcast signal is recorded in the digital hard disk of HDD 27 as digital image data via digital converting portion 25 and image compressing portion 26.

At this time, since the image data is recorded by files of a fixed length in area E3 or E4, every time a file of the image data is crated, file information Fi for that file is created in image recording information RFj. When the image data is written in the file and the file is filled with image data, main CPU 20 writes used address area information UAD indicating the used address area in area E3 or E4 for that file to file information Fi, and writes end sign ES to that file information Fi. Thus, the file of file information Fi is closed normally. Thereafter, main CPU 20 writes image data for the next file similarly, and writes information for the next file information F(i+1).

When such a sequence of image data recording is carried out by files, main CPU 20 successively updates, in user information UF of area E1, current state information UFA, current program name UFB and file information identifier UFC. When sub-CPU 10 determines that the scheduled image recording reaches the ending time point by matching the program ending time of the scheduling information of alarm register 53 and real time measured by time-measuring counter 51 (YES at F9), it notifies PVR portion 1 of an image recording ending notice (F 10).

When main CPU 20 of PVR portion 1 receives the image recording ending notice via interface 31 (YES at F25), it writes used address area information UAD as well as end sign ES to file information for the file to which image data has been currently written, for example file information Fn (F26).

At this time, an identifier for current film information Fn is written to file information identifier UFC of user information UF.

Thereafter, main CPU 20 notifies sub-microcomputer 4 of the image recording ending via interface 31 (F27). When sub-CPU 10 of sub-microcomputer 4 receives the image recording end notice (YES at F11), it outputs power source control signal 60 to cause the apparatus enter into the standby mode (F12). Thus, the operation of scheduled image recording ends.

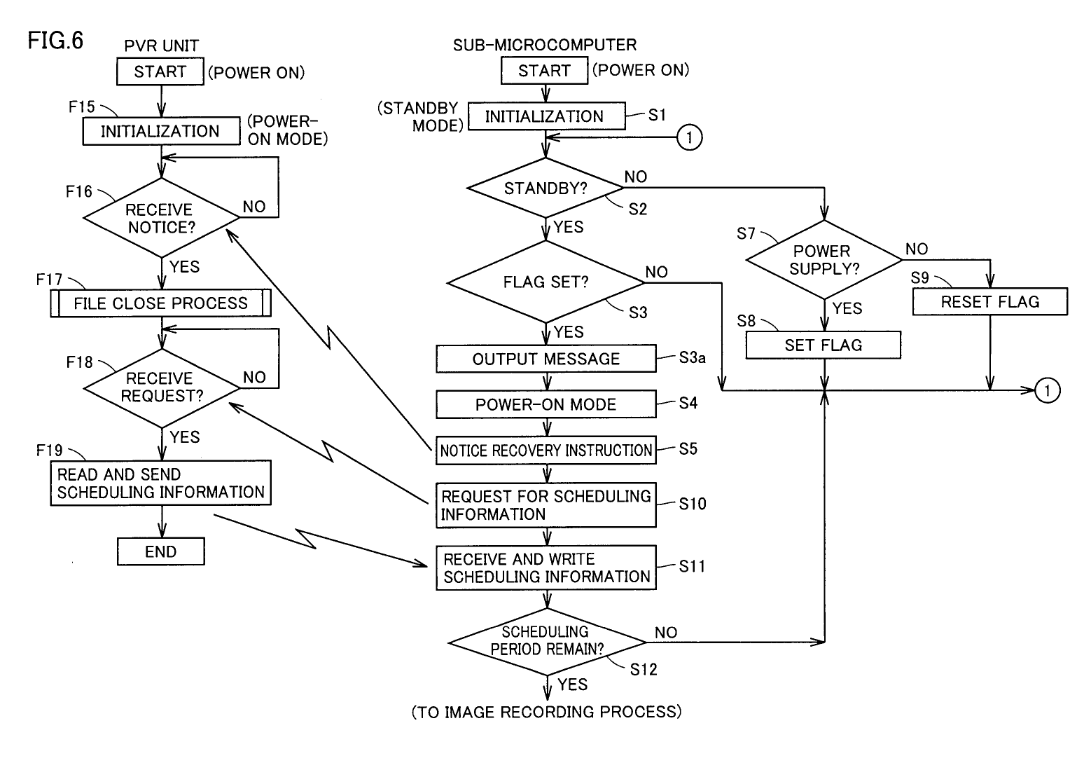

During the above-described scheduled image recording operation, if the image recording operation is interrupted while recording to a file due to a power failure or the like, the file becomes an image file that can not be read/write as described above. Accordingly, the process shown in the flowchart of FIG. 6 is carried out in order to recover the image file.

Referring to FIG. 6, sub-CPU 10 of sub-microcomputer 4 initializes memory 12 and the like to enter into the standby mode, after power is started to be supplied from power source 6 as plug 7 is inserted into the outlet (Step S (hereinafter simply referred to S) 1). After initialization is carried out following the start of the power supply from power source 6 (S1), since sub-CPU 10 determines that the current mode is the standby mode (YES at S2), and it determines if flag FL of flag register 52 is set or not (S3). If it is not set (NO at S3), then the process goes back to S2.

After initialization is carried out (S1) and the standby mode is entered, if sub-CPU 10 determines that it is not in the standby mode (NO at S2) and also that the power supply from power source 6 to PVR portion 1 is stopped (NO at S7) because of plug 7 being unmated by the user, the power failure or the like, then sub-CPU 10 resets flag FL (S9) and the process goes back to S2. If the power-on mode, the scheduled image recording mode or the like is entered and power is supplied to PVR portion 1 (NO at S2, YES at S7), sub-CPU 10 sets flag FL (S8) and the process goes back to S2.

As above, since the loop process of S2, S7 and S9 is repeated while power is supplied to PVR portion 1, flag FL is remained to be set by sub-CPU 10. During this period, the scheduled image recording operation shown in FIG. 5 is executed.

However, if the power supply from power source 6 to each portion is interrupted due to a sudden power failure or the like during the scheduled image recording operation, sub-CPU 10 can not reset flag FL and thus flag FL remains to be set.

After such a sudden power failure, when the apparatus is recovered from the power failure and the supply of power is started again, the above-described initialization process (SI) is carried out and the standby mode is entered. Then, sub-CPU 10 determines that flag FL is set (YES at S2, YES at S3). When flag FL is determined to be set as above, it is regarded that the previous image recording operation is interrupted and flag FL is remained to be set. Therefore, sub-CPU 10 generates a message indicating it to display it on output portion 13 (S3a), outputs power source control signal 60 for recovering the file and the like and cause the apparatus to enter into the power-on mode (S4), and sends a notice to PVR portion 1 for instructing the recovery of the file (S5).

As main CPU 20 of PVR portion 1 enters into the power-on mode, it carries out the initialization process of RAM 21, ROM 22 and the like (F15). As it receives the notice of instructing the recovery of the file from sub-CPU 10 (YES at F16), it carries out a file close process for the file recovery based on the instruction (F17).

Specifically, it refers to file information identifier UFC of user information UF of HDD 27, and specifies file information Fi corresponding to the file being written with an image data through an image recording operation immediately prior to the interruption of the previous power supply, and detects used address area information UAD for the corresponding image data file and writes it together with end sign ES to the specified file information Fi. Thus, the corresponding image data file is recovered to a state capable to be read or written. Therefore, even when the power supply is interrupted unexpectedly, the file close process of the file having been recorded is carried out at the start of a power supply that follows. Thus, all of the image recording files up to that point can be recovered as effective files that can be playback.

When the power supply is interrupted during the scheduled image recording, the apparatus operates as follows in order to resume the scheduled image recording.

First, sub-CPU 10 requests to obtain scheduling information to PVR portion 1 in order to recover the scheduling information of alarm register 53 that has been deleted by the power source interruption. Then, main CPU 20 specifies image recording information RFj having corresponding program name information RFA based on current program name UFB of user information UF of HDD 27. Then, main CPU 20 reads scheduling information RFB of thus specified image recording information RFj and notifies sub-microcomputer 4 of the same (S10, F18, F19).

Sub-CPU 10 of sub-microcomputer 4 receives the scheduling information from main CPU 20 and writes it to alarm register 53 of RTC 5 (S11). Thus, in case of a power failure of the like, alarm register 53 is supplied with an auxiliary power from battery portion 8. Even when the power supply is not enough and the scheduling information of alarm register 53 is deleted, it can be recovered. Then, sub-CPU 10 compares the image recording end time that is newly written to alarm register 53 and the real time measured by time-measuring counter 51. If it determines that there is no remaining period in the scheduled image recording period (NO at S12), the process of this time ends. If it determines that there is remaining period (YES at S12), then the image recording process of steps F6-F10 and F23-F27 in FIG. 5 is carried out as above. Thus, the interrupted scheduled image recording operation can be started again to continue image recording.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image recording apparatus, comprising:
a recording portion being supplied with power to record at least digital image information in a recording medium by files; and
a control unit operating when being supplied with said power to control said recording portion,
said control unit including
recovery means for controlling said recording portion, when a power supply to said control unit is started and if a previous power supply is found to be interrupted during a recording operation, to retrieve a file having been recorded at the interruption of the power supply from said files and to close the retrieved file.

2. The image recording apparatus according to claim 1, wherein
said control unit further includes
flag setting means for setting a pre-prepared flag during a period in which power is supplied to said recording portion, and for resetting said pre-prepared flag when power to said recording portion is interrupted, and
power interruption detecting means for detecting, when a power supply to said control unit is started and if said flag is determined to be set, an interruption of a previous power supply during a recording operation.

3. The image recording apparatus according to claim 2, wherein
recorded contents of said recording medium are retained after the interruption of the power supply,
said control unit further including
an information storing portion retaining pre-recorded information during a period in which power is supplied to said control unit,
scheduling information recording means for accepting scheduling information for scheduling said recording operation by said recording portion and recording the accepted scheduling information in said recording medium and in said information storing portion, and
supply start time recording means for recording said scheduling information read from said recording medium in said information storing portion, when a power supply to said control unit is started.

4. The image recording apparatus according to claim 3, wherein
said scheduling information includes scheduling period data for scheduling a period of said recording operation,
said control unit further including
a real time clock measuring real time, wherein
when a power supply to said control unit is started and if the real time measured by said real time clock is in a scheduling period indicated by said scheduling period data of said scheduling information recorded in said information storing portion by said supply start time recording means, said control unit causes said recording portion to resume said recording operation based on said scheduling information.

5. The image recording apparatus according to claim 4, wherein
said recording medium is a hard disk.

6. The image recording apparatus according to claim 5, further comprising
a playback portion playing back and outputting the recorded contents of said recording medium.

7. The image recording apparatus according to claim 6, wherein
power is supplied from a commercial power source, and the power supply from said commercial power source is interrupted by a power failure.

8. The image recording apparatus according to claim 1, wherein
recorded contents of said recording medium are retained after the interruption of the power supply,
said control unit further including
an information storing portion retaining pre-recorded information during a period in which power is supplied to said control unit,
scheduling information recording means for accepting scheduling information for scheduling said recording operation by said recording portion and recording the accepted scheduling information in said recording medium and in said information storing portion, and
supply start time recording means for recording said scheduling information read from said recording medium in said information storing portion, when a power supply to said control unit is started.

9. The image recording apparatus according to claim 8, wherein
said scheduling information includes scheduling period data for scheduling a period of said recording operation,
said control unit further including
a real time clock measuring real time, wherein
when a power supply to said control unit is started and if the real time measured by said real time clock is in a scheduling period indicated by said scheduling period data of said scheduling information recorded in said information storing portion by said supply start time recording means, said control unit causes said recording portion to resume said recording operation based on said scheduling information.

10. The image recording apparatus according to claim 1, wherein
said recording medium is a hard disk.

11. The image recording apparatus according to claim 1, further comprising
a playback portion playing back and outputting the recorded contents of said recording medium.

12. The image recording apparatus according to claim 1, wherein
power is supplied from a commercial power source, and the power supply from said commercial power source is interrupted by a power failure.

13. An image recording method, comprising:
a recording step of being supplied with power from a power source to record at least digital image information in a pre-prepared recording medium by files;
a power interruption detecting step of detecting if previous power supply is interrupted during a recording operation; and
a recovering step of retrieving a file having been recorded at the interruption of the power supply from said files in said recording medium and closing the retrieved file, if the interruption of the power supply is detected in said power interruption detecting step.
